(19) United States
(12) Patent Application Publication
(10) Pub. No.: US 2012/0234149 A9
(43) Pub. Date: Sep. 20, 2012

(54) Counter-Die For The Cylinders of Rotary Die Cutting Machines

(75) Inventor: Elias Adolfo Bengoa Rodriguez, Torroso-Mos (ES)

(73) Assignee: Rotary DieCutting Montenegro, S.A., Torroso-Mos (ES)

(21) Appl. No.: 12/723,258

(22) Filed: Mar. 12, 2010

Related U.S. Application Data
(63) Continuation of application No. PCT/ES2008/000501, filed on Jul. 16, 2008.

(30) Foreign Application Priority Data
Sep. 14, 2007 (ES) P200702448

(51) Int. Cl. B26D 1/20

(52) U.S. Cl. 83/508

(57) ABSTRACT

Specially designed to form an element that is easy and fast to install, with a long useful life and which improves the expulsion of residues after stamping, the counter-die of the invention is composed of a tubular body, divided into several parts (1-1′-1″) and joined to each other by tongue and groove joints using twisted edges (2) at the ends, preferentially three parts, these having an inner sector (3) which is the largest, of injected plastic, very resistant and light, over the exterior surface of which there is a coating (4) of polyurethane. The parts are joined to each other by orifices and grooves in their ends, more specifically in the area made of injected plastic, through which the respective rods or pins (11) pass.

### OBJECT OF THE INVENTION

This invention refers to a counter-die or dolly, that is, an element which is used to cover the cylinder on which the die acts, with the aim of preventing damage to the blades of the latter.

The object of the invention is to attain a counter-die that is easy and fast to fit onto the cylinder, with a long useful life and which improves the expulsion of residues after stamping, as well as a series of additional advantages that will be described throughout this document.

### BACKGROUND OF THE INVENTION

As it is known, in rotary stamping machines two cylinders work, between which the piece to be stamped is placed, while one of the cylinders includes the blades of the die itself, while the other functions as the stamping base.

This cylinder that works as the base for stamping is made of steel, and to ensure that the blades of the die are not damaged during stamping, it is equipped with a dolly made of a relatively soft material, usually polyurethane.

More specifically, the said dolly takes the form of a thick band that surrounds the cylinder, I.e., it forms a type of casing that is also cylindrical, with the particularity that it has two metal shapes in the area of its opening, which together form a key that fits into a groove or keyway, where in some cases the said key is affixed by bolts and in others by different means.

The problem with dollies or counter-dies of this type is that they do not have good dimensional stability that would make it possible to maintain the circumferential diameter throughout the whole lifetime of the device, as its support lacks rigidity, making them liable to suffer dilation due to thermal effects.

Additionally it should be pointed out that devices of this type are difficult to implement, giving rise to high maintenance costs due to the long times machines have to be taken out of service so that they can be replaced.

Apart from the problem described above, it also has to be said that counter-dies do not usually fit the cylinder perfectly, making it possible for them to move in certain ways that are negative for the stamping process.

### DESCRIPTION OF THE INVENTION

The counter-die proposed resolves the above problems in a fully satisfactory way, in all of the different aspects mentioned.

To this end and more specifically, the said counter-die takes the form of a tubular body, based on two layers, one thicker interior layer obtained using injected plastic, rigid, consistent and with very stable dimensions, and an exterior layer or coating based on vulcanized consumable polyurethane, which ensures any possible dilations that occur are minimum, as well as more regular and uniform.

The said set therefore offers maximum dimensional stability, making it possible to keep a uniform diameter of circumference throughout the whole useful life of the device.

According to another of the characteristics of the invention, the said tubular body that forms the counter-die is divided into a series of parts that may be fitted together circumferentially, preferentially three parts, including a connection system that makes the maneuver of replacing the said counter-die extremely fast and simple, as it is composed of parts which are very light in weight and easy to handle, notably reducing the times that the machine is out of service.

More specifically, the connection system between the parts that make up the counter-die takes the form of a tongue and groove joint around the edge at each end of each part, in such a way that in one of the said ends, and corresponding to the sector obtained using injected plastic, there is a hole that passes through, while on the opposite one there is an “L” shaped groove, so that when connecting the tongue and groove joint between opposite ends of the three parts, respective rods are simultaneously inserted and pass through the through-holes as well as through the “L” shaped grooves, making it possible for the said rods to move along the said “L” shaped grooves, thereby aiding the maneuver of assembly, as gaps are permitted when the said rods are located on the long section of the said “L” shaped groove, while they are perfectly connected and fitted according to their size when they are moved to the final position of assembly, that which corresponds to their position over the short arm or section of the “L”.

It is designed so that the interior diameter of the device will be greater than that of the cylinder on which polyurethane is fitted, making the effect of a “bearing” or of free turning on the cylinder possible, an advantage which permits the die to move relatively to the counter-die while working at the same speed and preventing tears and excessive forces, which increases the lifespan of the counter-die and the die itself, while also obtaining increasing stability of the dimensions of the stamped plate.

It should be underlined that the sector or interior parts of the counter-die, those which are obtained using injected plastic, are reusable elements, thereby reducing the problem of waste elimination and decreasing environmental impact.

According to another one of the characteristics of the invention, it has been designed so that the system is equipped with a set of rings located on the ends of the cylinder, which make it possible to control the total dilation of the set as well as to restrict the lateral movement of the units on the cylinder.

In this way the polyurethane lasts for longer, permitting major savings in the consumption of covers, as well as a series of advantages, among which the following stand out:
It always permits stamping with a stable, minimum and constant penetration of the blade.
It offers perfect control of the measurements of the box to be stamped.
Wear of the polyurethane layer is uniform.
The expulsion of wastes and residues is improved, especially when working at low pressure.
It improves the marking of splits without breaking the paper inside.
It makes it possible to use cut-split bands without going through the paper.
Less maintenance.
Increased productivity due to the shorter times when the machine is out of service due to rotation of the polyurethane sections or repairs to the die.
The interior elements are reusable, and it is possible to collect the unused polyurethane.
It is possible to produce complicated designs of boxes that to date could only be stamped using flat stampers.

### DESCRIPTION OF THE DRAWINGS

To complement the description being given and with the aim of aiding better comprehension of the characteristics of the invention, according to a preferential example of the practical execution of the same, the said description is accompanied, as an integral part of the same, by a set of drawings in which as illustrations and not restrictively, the following are shown:

FIG. 1. This shows, according to a diagrammatic representation in perspective, a counter-die executed according to the object of the invention.

FIG. 2. This show a detail in perspective of one of the parts of the counter-die, without the external cover of polyurethane.

FIG. 3. this shows a side view of the same part as the previous figure.

### PREFERRED EMBODIMENT OF THE INVENTION

In the light of the said figures, it may be seen that the counter-die proposed by the invention takes the form of a tubular body, obtained on the basis of three parts (1-1′-1″) which are joined together, for which purpose they have an edge (2) that is bent and complementary respecting its opposite edge, in order to create the means of groove and tongue connection and a continuous surface for the said tubular body.

As may be observed in FIG. 2, the said parts (1-1′-1″) include a sector that is interior and the largest (3), made from injected plastic, together with an exterior coating of polyurethane (4) applied by means of vulcanization.

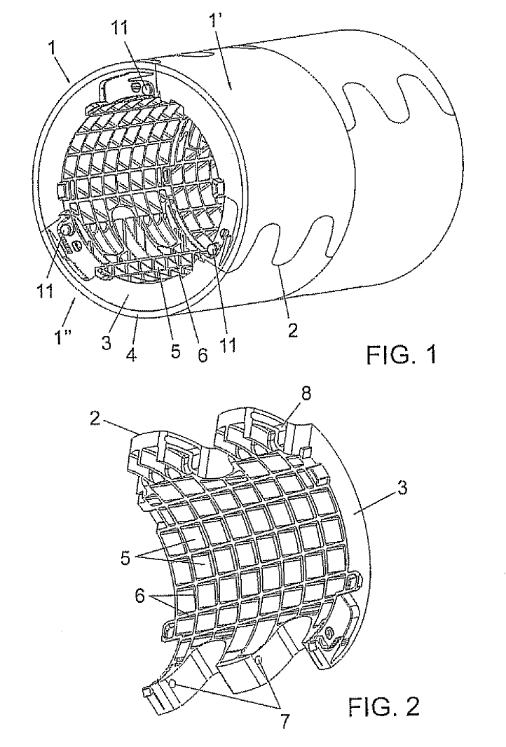

To make the said parts (1-1′-1″) elements which are light and easy to handle, they are equipped on their inner surface with sunken areas (5) which form brackets (6) that increase rigidity, all as may be seen in FIG. 1.

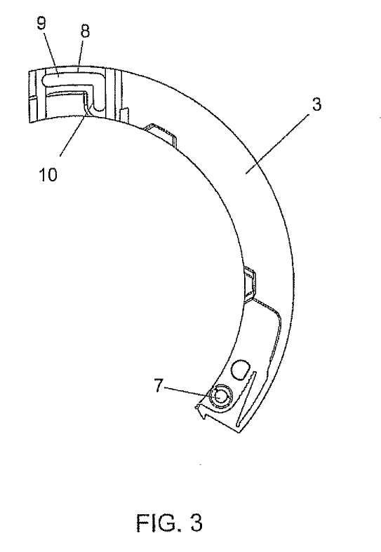

Regarding the means for affixing the said three parts (1-1′-1″) to each other, they are equipped, at the level of their internal sector (3) of injected plastic, and on one of their ends, with an orifice that passes through the same (7), which acts on the protuberances created by the bent edge (2) described above, while at its other end, as may be observed in FIG. 3, it includes an “L” shaped groove which when ready for assembly is opposed to the said hole (7), in order to permit the insertion of a fixing rod (11), as shown in FIG. 1, which is able to move along the sector (9) and mainly in the said groove (8), facilitating the maneuvers of assembling the device, as it allows the play of the fixing rod over the said sector to increase the internal diameter of the device and thereby to offer a gap to make it easier to put into position, so that when the parts are pressed together, the rod moves to the elbow (10) of the said groove (8), locking into place and achieving the perfect fit of the device.

The counter-die is complemented, as was pointed out above, with a set of limiting rings, which may be adjustable or fixed, and which are placed over the ends of the cylinder, making it possible to control the dilation of the device and to restrict the lateral movement of the units on the cylinder.

1. A counter-die for the cylinders of rotary die-cutting machines, of the type used to cover the cylinder on which the die acts, with the aim of preventing deterioration of the blades of the latter, characterized by the fact that it is composed of a tubular body, divided into several parts (1-1′-1″) that may be fitted together using tongue and groove joints, preferentially in sets of three, these parts having an inner sector (3) and which is larger, usually of injected plastic, on the exterior face of which it is coated (4) in polyurethane, while the parts include the means of quickly interconnecting them.

2. A counter-die for the cylinders of rotary die-cutting machines, according to claim 1, characterized by the fact that the said parts (1-1′-1″) rave the edges of their ends which are for connecting them to each other (2) with a bent configuration, and the said means of rapid connection take the form of through orifices (7) that act on the protruding edges formed by the bent edge (2), on one of the ends of the intermediate sector (3) of injected plastic, as well as additional “L” shaped grooves (8) in the protruding edges of the contrary end, which in shape and size are suitable so that prepared for assembly they are opposed to the said orifices (7), coupling being designed to occur using the respective fixing rods (11) that pass through the said orifices and grooves.

3. Counter-die for the cylinders of rotary die-cutting machines, according to claim 1, characterized by the fact that the intermediate sector (3), made from injected plastic, has on its inner surface a plurality of sunken areas (5) to make it lighter, which form brackets (6) to increase rigidity (6).
